(19) United States
(12) Patent Application Publication
(10) Pub. No.: US 2019/0360828 A1
(43) Pub. Date: Nov. 28, 2019

(54) SYSTEM AND METHOD FOR PROVIDING TRANSPORT SERVICE

(71) Applicant: BEIJING DIDI INFINITY TECHNOLOGY AND DEVELOPMENT CO., LTD., Beijing (CN)

(72) Inventor: Yu ZHANG, Beijing (CN)

(73) Assignee: BEIJING DIDI INFINITY TECHNOLOGY AND DEVELOPMENT CO., LTD., Beijing (CN)

(21) Appl. No.: 16/535,006

(22) Filed: Aug. 7, 2019

Related U.S. Application Data
(63) Continuation of application No. PCT/CN2017/103139, filed on Sep. 25, 2017.

(51) Int. Cl. G01C 21/34; G01C 21/36; G06K 9/62

(52) U.S. Cl. CPC G01C 21/3438; G01C 21/3453; G06K 9/6267; G06K 9/6218; G01C 21/3605

(57) ABSTRACT

Embodiments of the disclosure provide a system and method for providing transport service. The method may include receiving, via a communication interface, transport tasks within an area. The method may further include clustering, by a processor, the transport tasks into groups, and searching for, by the processor, transport capacity for the groups. The method may also include assigning, via the communication interface, the transport capacity to each group.

### CROSS REFERENCE TO THE RELATED APPLICATIONS

The present application is a continuation of International Application No. PCT/CN2017/103139 filed on Sep. 25, 2017, designating the United States of America. The entire contents of the above-referenced application are incorporated herein by reference.

### TECHNICAL FIELD

The present disclosure relates to transport service, and more particularly, to systems and methods for providing transport service.

### BACKGROUND

Car-pooling becomes an emerging transportation method. Through car-pooling, the usage of a vehicle can be improved by allowing passengers in a same route to share a vehicle. For example, a car-pooling platform (e.g., DiDi™) can assign a vehicle to pick up passengers at different locations in a route and drop the passengers as requested. However, with more passengers requesting the transport service, the car-pooling platform may have to generate a plurality of routes and assign a plurality of vehicles to the routes. Therefore, it is important to efficiently assign transport capacity.

Embodiments of the disclosure provide systems and methods for providing transport service, to improve the efficiency for providing transport service.

### SUMMARY

Embodiments of the disclosure provide a computer-implemented method for providing transport service. The method may include receiving, via a communication interface, transport tasks within an area. The method may further include clustering, by a processor, the transport tasks into groups, and searching for, by the processor, transport capacity for the groups. The method may also include assigning, via the communication interface, the transport capacity to each group.

Embodiments of the disclosure further provide a system for provide transport service. The system may include a communication interface configured to receive transport tasks within an area, a memory, and a processor coupled to the communication interface and the memory. The processor can be configured to: cluster the transport tasks into groups, search transport capacity for the groups, and assign the transport capacity to each group.

Embodiments of the disclosure further provide a non-transitory computer-readable medium that stores a set of instructions, when executed by at least one processor of an electronic device, cause the electronic device to perform a method for providing transport service. The method may include receiving transport tasks within an area, clustering the transport tasks into groups, searching for transport capacity for the groups, and assigning the transport capacity to each group.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system for providing transport service, according to embodiments of the disclosure.

FIG. 2 illustrates a schematic diagram of exemplary transport tasks distributed in an area, according to embodiments of the disclosure.

FIG. 3 illustrates a schematic diagram of exemplary task groups, according to embodiments of the disclosure.

FIG. 4 illustrates a schematic diagram of exemplary ordered groups, according to embodiments of the disclosure.

FIG. 5 is a flowchart of an exemplary method for providing transport service, according to some embodiments of the disclosure.

FIG. 6 is a flowchart of an exemplary method for dividing a group into two sub-groups, according to embodiments of the disclosure.

FIG. 7 is a flowchart of an exemplary method for assigning transport tasks to respective vehicles, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Systems and methods according to embodiments of the disclosure can divide transport tasks into groups and dynamically adjust the distribution of transport capacity within each group to improve the efficiency of transportation.

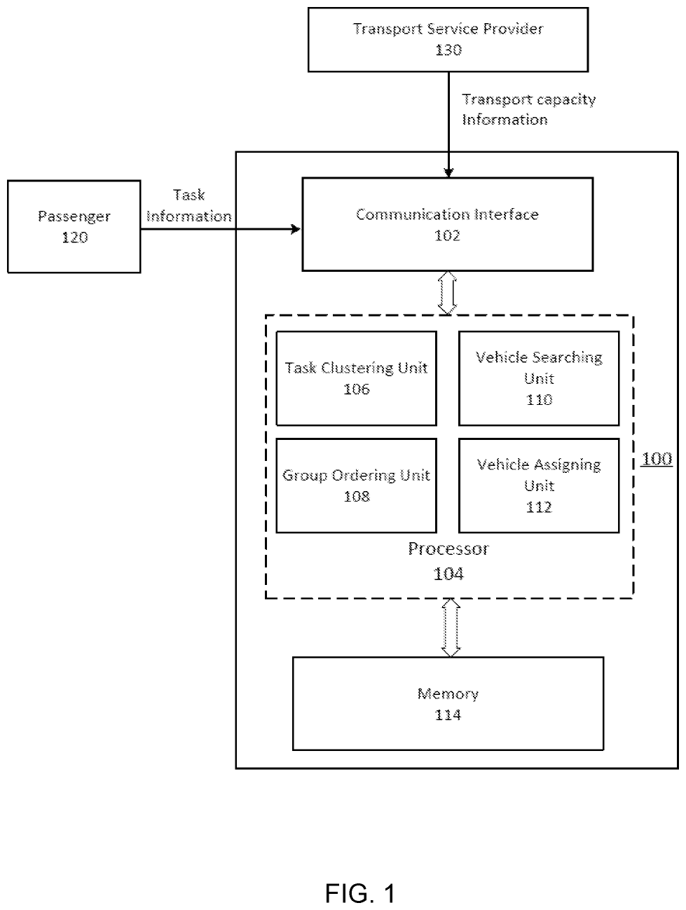

FIG. 1 illustrates a block diagram of an exemplary system 100 for providing transport service, according to embodiments of the disclosure.

System 100 can be a general server or a proprietary device. In some embodiments, as shown in FIG. 1, system 100 may include a communication interface 102, a processor 104, and a memory 114. Processor 104 may further include multiple functional modules, such as a task clustering unit 106, a group ordering unit 108, a vehicle searching unit 110, a vehicle assigning unit 112, and the like. These modules (and any corresponding sub-modules or sub-units) can be functional hardware units (e.g., portions of an integrated circuit) of processor 104 designed for use with other components or a part of a program. The program may be stored on a computer-readable medium, and when executed by processor 104, it may perform one or more functions. Although FIG. 1 shows units 106-112 all within one processor 104, it is contemplated that these units may be distributed among multiple processors located near or remotely with each other. In some embodiments, system 100 may be implemented in the cloud, or on a separate computer/server.

Communication interface 102 may be configured to receive transport tasks within an area. The transport tasks are requested by at least one passenger 120. Communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In any such implementation, communication interface 102 can send and receive electrical, electromagnetic or optical signals that carry digital data streams representing various types of information via a network (not shown). The network can typically include a cellular communication network, a Wireless Local Area Network (WLAN), a Wide Area Network (WAN), or the like.

At least one passenger 120 can send a request to a car-pooling platform (e.g., DiDi online platform), indicating task information of the transport tasks. In some embodiments, the task information can include a requester identity of the transport task (e.g., passenger 120), an origin of a trip, a destination of the trip, a departure time of the trip, and the like.

In some embodiments, passenger 120 can make the request on a mobile device (e.g., a smart phone, a tablet, a smart watch, or the like) using a mobile application (e.g., a DiDi app). The mobile application can invoke a positioning module (e.g., a GPS module) of the mobile device to locate the passenger, and set the current location of the passenger as, for example, the origin of the trip and the requested destination as a destination. Passenger 120 can also identify a location other than the current location as the origin. In some embodiments, the passenger can also send the request to the car-pooling platform via a website, indicating the task information. It is contemplated that, the task information can further include any necessary information, such as the requirement for the vehicle, a number of passengers in this transport task, or the like.

Communication interface 102 can be further configured to receive transport capacity information from at least one transport service provider 103 (e.g., private car owners, taxis drivers, a transport service company, or the like). The transport capacity information can include, for example, an identity of the driver, passenger capacity of the vehicle, a vehicle model, a location of the vehicle or the like.

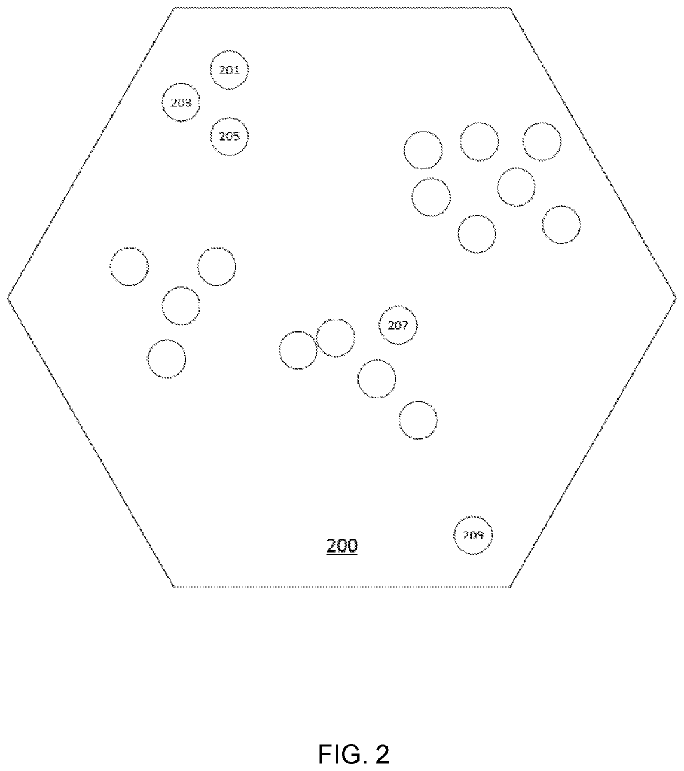

The received transport tasks and transport capacity information can be further processed by processor 104. For example, task clustering unit 106 can be configured to cluster the transport tasks into groups. FIG. 2 illustrates a schematic diagram of exemplary transport tasks distributed in an area 200, according to embodiments of the disclosure.

Area 200 can be, for example, a hexagon, and the transport tasks can be distributed within area 200. As discussed above, the transport task can include an origin, a destination, and a departure time of the trip. Whether a transport task distributed within area 200 can be determined according to the origin, the destination, and the departure time of the trip.

As shown in FIG. 2, transport tasks 201-209 and some other tasks are determined to be distributed within area 200. Task clustering unit 106 can cluster the transport tasks according to the task information including the identity of passenger 120, the origin of the trip, the destination of the trip, the departure time of the trip. That is, task clustering unit 106 can cluster the transport tasks according to geographic locations (e.g., the origin and the destination) and a time perspective (e.g., the departure time). It is contemplated that, before the clustering, task clustering unit 106 may further perform filtering on the received transport tasks to remove abnormal tasks. For example, a transport task having too many passengers (e.g., more than ten passengers) may be filtered out.

Area 200 can be mapped to a coordinate system to locate the tasks with coordinates. In some exemplary embodiments, tasks clustered in a group may have same or similar origins, destinations, and departure times. For example, task 201 has an origin at (0.35, 7.3) and a departure time at 6:50 am, task 203 has an origin at (−0.35, 7.04) and a departure time at 6:45 am, task 205 has an origin at (0.35, 6.76) and a departure time at 6:55 am, task 207 has an origin at (1.71, 5.25) and a departure time at 7:15 am, and task 209 has an origin at (2.31, 3.57) and a departure time at 7:35 am. Task clustering unit 106 may identify that the distances between origins of tasks 201, 203, and 205 are each less than a predetermined distance (e.g., 1 unit in the coordinate system). The processing of the destinations of transport tasks can be similar to that of the origins, and the description is omitted herein.

Then task clustering unit 106 may further determine if the departure times of these tasks 201, 203, and 205 are close enough to be clustered into a same group. For example, task clustering unit 106 may determine, among tasks 201, 203, and 205, the earliest departure time is 6:45 am and the latest departure time is 6:55 am, and the time difference between the earliest departure time and the latest departure time is less than a predetermined range (e.g., 15 minutes). Accordingly, task clustering unit 106 may cluster tasks 201, 203, and 205 into a first group. In FIG. 2, task 207 has an origin at (1.7, 5.3) and a departure time at 7:30 am. The distance between task 207 and any task in the first group is greater than predetermined distance (e.g., 1 unit in the coordinate system) and the time difference between task 207 and any task in the first group is greater than the predetermined range (e.g., 15 minutes). Therefore, task clustering unit 106 may not include task 207 in the first group.

It is possible that task 207 can be clustered into one group along with other task having similar origins, destinations, and departure times. The destinations of tasks within a group may or may not be identical. When the destinations are not identical, the tasks within the same group may nevertheless share a generally same direction. Therefore, the exemplary destinations for these tasks will be omitted herein. System 100 may design a route for tasks in the same direction to drop the passengers when necessary. It is contemplated that more similar the destinations are, the more efficient the system may provide the transport service.

In some embodiments, task clustering unit 106 can also cluster transport tasks using a clustering model. The clustering model may analyze feature elements (e.g., the origins, destinations, and departure times) of the transport tasks, and cluster similar transport tasks into a group. The clustering model can have a grain for clustering transport tasks, and the grain can include, for example, the predetermined distance between origins (or destinations) of tasks, the predetermined range for time difference between tasks, and the like. If the grain is too fine, very few tasks can be clustered into one group, and if the grain is too coarse, on group can contain too many tasks. Thus, the grain can be adjusted to make sure a proper number of tasks can be clustered into one group. The feature elements for task clustering unit 106 are not limited by above examples.

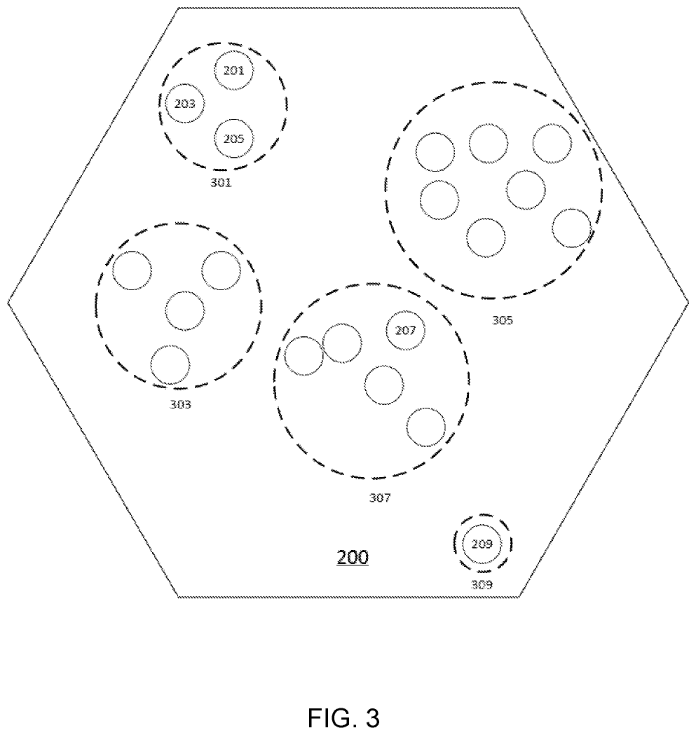

FIG. 3 illustrates a schematic diagram of exemplary task groups, according to embodiments of the disclosure. As shown in FIG. 3, tasks 201-205 are clustered into a group 301, task 207 and some other tasks are clustered into a group 307, task 209 is clustered as a group 309 by itself, and other tasks are clustered into groups 303 and 305.

Task clustering unit 106 may further determine a rendezvous time for each group based on the departure times of the transport tasks in the group, wherein the rendezvous time of each group is an average departure time of transport tasks in the respective group. For example, the rendezvous time of group 301 can be an average departure time of the departure time 6:50 am, 6:45 am, and 6:55 am. That is, the rendezvous time of group 301 may be determined as 6:50 am. The rendezvous time will be the time when the vehicle picks up the passengers of the group.

Similarly, task clustering unit 106 may determine a rendezvous location and an arrival location based on the origins and destinations of the transport tasks in each group. In some embodiments, the rendezvous location of respective groups may be an average location of the origins of the transport tasks in the respective groups. For example, the origins of tasks 201-205 in group 301 are (0.35, 7.3), (−0.35, 7.04), and (0.35, 6.76), and accordingly the average location may be (0.11, 7.03). In some embodiments, the rendezvous location can be further adjusted according to the map information based on the average location. For example, the rendezvous location may be determined as a crossroad near the average location. The arrival location can be the destination of the last passenger to be dropped off or an average location of the destinations in the group.

Task clustering unit 106 may further estimate an end time for each group. The end time of a group can be generated by a navigation service (e.g., DiDi™). For example, the rendezvous location, the arrival location, and the rendezvous time of the group may be sent to the navigation service provider to design a trip for the group, as well as the estimated end time for the trip. It is contemplated that the navigation service can be a function provided by system 100 or by a system separate from system 100.

Therefore, task clustering unit 106 may cluster the transport tasks into groups, and generate a rendezvous location, an arrival location, a rendezvous time, and an end time of the transport service for the group.

Group ordering unit 108 can be configured to order the groups according to the rendezvous times associated with the respective groups. In some embodiments, generally, for a target group, a first group having a rendezvous time earlier than the target group can be determined as a preceding group, and a second group having a rendezvous time later than the target group can be determined as a subsequent group. However, it is possible for a group to have no preceding group, in which case the group can be determined as a parent group.

A transport service provider may only take another task of a next group if the current task of the current group has been finished. Therefore, a rendezvous time of the next group may be set to be after the end time of a current group. In some embodiments, a time different between the rendezvous time of the next group and the end time of the current group can be associated with a distance between the rendezvous location of the next group and the arrival location of the current group. For example, the navigation service can estimate a period for the transport service provider to travel the above distance between the two groups. When the estimated period is less than the time difference, the next group can be determined as the subsequent group. The distance between the rendezvous location of a next group and the arrival location of a current group can be determined as the distance between the current group and the next group.

In some embodiments, for a target group, more than one candidate group can meet the above conditions. Group ordering unit 108 may select one candidate group as the subsequent group using a greedy algorithm. The greedy algorithm can always select the subsequent group that offers obvious benefit. For example, the greedy algorithm may select a subsequent group that has a shortest distance from the target group.

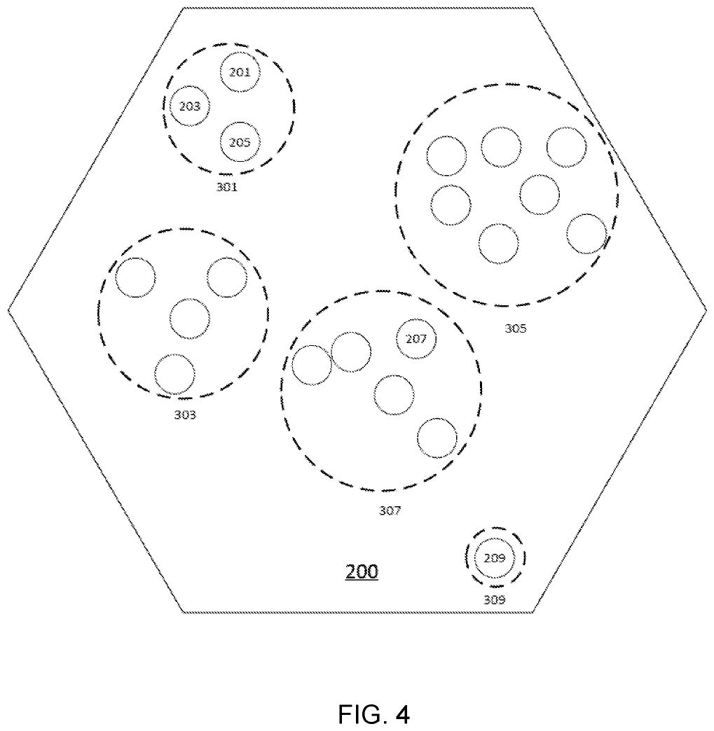

FIG. 4 illustrates a schematic diagram of exemplary ordered groups, according to embodiments of the disclosure. As shown in FIG. 4, each of groups 402-414 is associated with a rendezvous location (e.g., O1, O2, or the like), an arrival time (e.g., D1, D2, or the like), a rendezvous time (e.g., 7:00, 8:00, or the like), and a number of passengers (e.g., 20, 10, or the like). These groups have been ordered by group ordering unit 108 as discussed above.

In some embodiments, when a vehicle finishes a car-pooling service for a current group, the vehicle may continue to provide the car-pooling service to a subsequent group. However, it is possible that the subsequent group may need more transport capacity for the transport tasks than the available transport capacity of the current group. In this case, group ordering unit 108 may further determine a capacity to be transferred from a first group to a second group. For example, as shown in FIG. 4, group ordering unit 108 may determine that transport capacity of only five passengers can be transferred from group 404 to group 406, which includes ten passengers looking for the car-pooling service. That is, five passengers cannot be properly served by the available transport capacity.

Group ordering unit 108 may then divide group 406 into a first sub-group 406′ and a second sub-group 408 when the transferred capacity is less than the transport capacity needed for original group 406. Group ordering unit 108 may further assign the transferred capacity (e.g., five passengers) to first sub-group 406′, and designate second sub-group 408 as a parent group. System 100 may assign new transport capacity to the parent group. For example, a new transport capacity of five can be assigned to group 408, which can be used to cover the capacity need of five of group 408. More details of assigning new capacity to group 408 will be described below.

In some embodiments, when a current group has enough transport capacity for its subsequent group, the transport capacity will be assigned to the subsequent group after the transport tasks for the current group are finished. For example, group 404 has transport capacity of 15 passengers, group 410 needs transport capacity of three passengers, and therefore the transport capacity of three passengers will be assigned to group 410. Furthermore, the extra transport capacity of 12 passengers can be assigned to another group (e.g., group 412).

In some embodiments, when a current group does not have enough transport capacity for its subsequent group, the subsequent group can acquire more transport capacity from another preceding group. For example, group 406 can provide transport capacity of 5 passengers, but group 414 needs transport capacity of 10 passengers. Therefore, group 414 can acquire transport capacity of the other 5 passengers from another preceding group 408. That is, one subsequent group may be assigned capacity from more than one preceding groups.

Vehicle searching unit 110 can be configured to search for transport capacity for the groups. Generally, the transport capacity that a transport service provider can offer is associated with the vehicle. For example, a five-passenger vehicle can provide service to four passengers at most, as the driver has to occupy one seat. Most of the vehicles can provide service to 2-6 passengers. Vehicle searching may be performed for the parent groups in a car-pooling service, because the parent groups are at the top of the chain without preceding groups. For example, vehicle searching unit 110 may search for available vehicles for each of parent groups 402 and 408. As discussed above, service provider 130 may send transport capacity information to system 100, indicating the capacity and location of his/her vehicle. Based on the acquired transport capacity information, available vehicles can be found by vehicle searching unit 110.

For example, with reference to FIG. 4, group 402, as a parent group, includes 20 passengers looking for a car-pooling service, and at least one vehicle in a neighborhood near group 402 may be located for providing transport capacity. The neighborhood may be expanded if transport capacity found is not enough.

Vehicle assigning unit 112 may assign the transport capacity to each group. In some embodiments, vehicle assigning unit 112 may generate a combination of vehicles according to the transport capacity of each vehicle and the transport tasks in the group, and determine a combination of vehicles for the group. For example, group 402 includes 20 passengers, and the combination of vehicles can be four 3-passenger vehicles and two 4-passenger vehicles. That is, a combination of six vehicles can be provided to group 402 to take the 20 passengers. It is contemplated that, more than one combination of vehicles can be generated when the available vehicles collectively provide transport capacity larger than the required capacity.

To improve efficiency of the car-pooling service, transport tasks for each of the passengers in one vehicle can have same or similar origins, destinations, departure times, and arrival times. That is, transport tasks assigned to one vehicle may be same or similar to improve the efficiency.

Therefore, in some embodiments, vehicle assigning unit 112 may further determine a similarity matrix for the transport tasks in the group (e.g., parent group 402), determine feature elements based on the similarity matrix, cluster the transport tasks into a predetermined number of classifications according to the feature elements, and assign the transport tasks to each of the at least one vehicle based on the plurality of classifications.

For example, the similarity matrix of the transport tasks can be generated using a similarity model. The similarity model can compare, for example, the origins, the destinations, the departure times, the arrival times and other feature elements of the transport tasks to generate the similarity matrix. Optionally, the similarity matrix can be converted to a Laplace matrix to generate feature elements for each of the transport tasks. The transport tasks can be clustered into a predetermined number of classifications. The predetermined number can be the number of vehicles for the group determined by vehicle assigning unit 112. The method for clustering can be a K-means method or a density-based clustering method (e.g., a maximum density method). It is contemplated that, the method for clustering is not limited by the above exemplary methods. After classification, transport tasks (e.g., passengers) can be respectively assigned to the vehicles. In some embodiments, the clustering process may be hidden from the user-end. That is, when a passenger is reviewing his/her choices of vehicles, only the vehicle that he/she has been assigned to can be displayed to the passenger.

It is contemplated that, vehicle assigning unit 112 may generate more than one combinations of vehicles. That is, the number of vehicles (i.e., the predetermined number of classifications) can change, the generated classifications can change accordingly. Thus, vehicle assigning unit 112 can generate classifications for each of the combinations of vehicles. For example, besides a first combination of four 3-passenger vehicles and two 4-passenger vehicles discussed above, group 402 can have a second combination of two 2-passenger vehicles, four 3-passenger vehicles, and one 4-passenger vehicle.

It is contemplated that, if the combination for a parent group changes, the combinations for subsequent group(s) may also change. For example, at the beginning, the first combination (i.e., four 3-passenger vehicles and two 4-passenger vehicles) and the second combination (i.e., two 2-passenger vehicles, four 3-passenger vehicles, and one 4-passenger vehicle) are both available for passengers of groups 402. As discussed above, one passenger can be displayed with, for example, a 3-passenger vehicle in the first combination, a 3-passenger vehicle in the second combination, and a 4-passenger vehicle in the second combination for his/her selection. When the passenger selects the 4-passenger vehicle in the second combination, other passengers in group 402 cannot select vehicles in the first combination any more. However, if the passenger selects the 3-passenger vehicle in the second combination, options for other vehicles in both the first and second combinations are still available for other passengers in group 402, because the first and second combinations both contain the 3-passenger vehicle. Therefore, vehicle assigning unit 112 can provide a plurality of combinations of vehicles for a passenger to select.

Vehicle assigning unit 112 can perform the above process for other groups (including another parent group or subsequent groups), and send the assignment of vehicles to the transport service provider via communication interface 102.

Thus, system 100 for providing transport service can cluster transport tasks into groups and dynamically adjust the distribution of transport capacity within each group to improve the efficiency of vehicles.

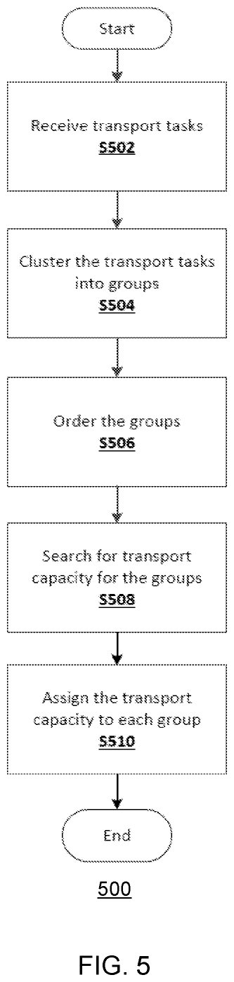

Another aspect of the disclosure is directed to a method for providing transport service. FIG. 5 is a flowchart of an exemplary method 500 for providing transport service, according to some embodiments of the disclosure. In some embodiments, method 500 may be implemented by system 100, and may include steps S502-S510.

In step S502, system 100 may receive transport tasks within an area. The transport tasks can be requested by at least one passenger. The transport tasks can contain task information, including an identity of the passenger, an origin of a trip, a destination of the trip, a departure time of the trip, and the like. The request can be sent from a mobile device or a desktop device. In some embodiments, the origin of the trip can be the current location of the passenger or another location designated by the passenger. It is contemplated that, the task information can further include any necessary information, such as the requirement for the vehicle, a number of passengers in this transport task, or the like.

System 100 may further acquire transport capacity information from at least one transport service provider. The transport capacity information can include, for example, an identity of the at least one transport service provider, passenger capacity of a vehicle, a vehicle model, a location of the vehicle, or the like.

In step S504, system 100 may cluster the transport tasks into groups according to the task information including the identity of the passenger, the origin of the trip, the destination of the trip, the departure time of the trip. It is contemplated that, before the clustering, the received transport tasks may be filtered to remove abnormal tasks.

System 100 may determine whether each of distances between origins (or destinations) of transport tasks is less than a predetermined distance. In some embodiments, when the distances are less than the predetermined distance, the transport tasks can be clustered into one group. System 100 may further determine if the departure times of these tasks are close enough to be clustered into a same group. As a result, transport tasks in a same group contain same or similar origins, destinations, and departure times.

System 100 may determine a rendezvous time based on the departure times of the transport tasks in each group, wherein the rendezvous time of respective groups is an average departure time of transport tasks in the respective groups. The rendezvous time will be the time when the vehicle picks up the passengers of the group.

Similarly, system 100 may determine a rendezvous location and an arrival location based on the origins and destinations of the transport tasks in each group. The rendezvous location of respective groups may be an average location of the origins of the transport tasks in the respective groups. It is contemplated that, the rendezvous location can be further adjusted according to the map information based on the average location. For example, the rendezvous location may be determined as a crossroad near the average location. In some embodiments, the arrival location can be the destination of the last passenger to be dropped off or an average location of the destinations in the group. System 100 may further estimate an end time for each group. The end time of a group can be generated by a navigation service (e.g., DiDi™).

It is contemplated that, system 100 can cluster transport tasks using a clustering model. The clustering model may analyze feature elements (e.g., the origins, destinations, and departure times) of the transport tasks, and cluster similar transport tasks into a group. The feature elements are not limited by above examples.

Therefore, system 100 may cluster the transport tasks into groups, and generate a rendezvous location, an arrival location, a rendezvous time, and an end time of the transport service for the group.

In step S506, system 100 may order the groups according to the rendezvous time associated with the respective groups. In some embodiments, generally, for a target group, a first group having a rendezvous time earlier than the target group can be determined as a preceding group to the target group, and a second group having a rendezvous time later than the target group can be determined as a subsequent group to the target group. However, it is possible for a group to have no preceding group, in which case the group becomes as a parent group.

A transport service provider may only take another task of a next group if the current task of the current group has been finished. Therefore, a rendezvous time of the next group may be set after the end time of the current group. In some embodiments, a time different between the rendezvous time of the next group and the end time of the current group can be associated with a distance between the rendezvous location of the next group and the arrival location of the current group. For example, the navigation service can estimate a period for the transport service provider to travel the above distance between the two groups. When the estimated period is less than the time difference, the next group can be determined as the subsequent group.

In some embodiments, for a target group, more than one candidate groups can meet the above conditions for the rendezvous time and the time difference. Group ordering unit 108 may select one candidate group as the subsequent group using a greedy algorithm. The greedy algorithm can always select the subsequent group that offers obvious benefit. For example, the greedy algorithm may select a subsequent group that has a shortest distance from the target group.

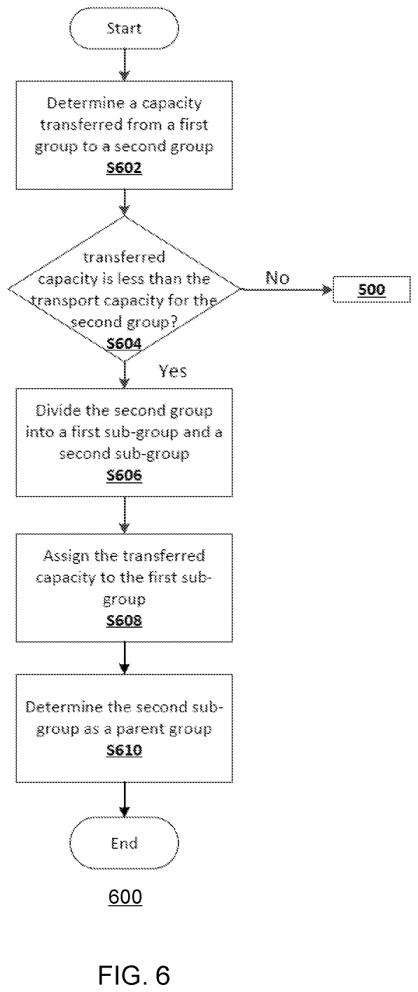

In some embodiments, step S506 may further include a method for dividing a group into two sub-groups. FIG. 6 is a flowchart of an exemplary method 600 for dividing a group into two sub-groups, according to embodiments of the disclosure. Method 600 may include steps S602-S610.

In step S602, system 100 may determine a capacity to be transferred from a first group to a second group. In step S604, system 100 may determine if the transferred capacity is less than the transport capacity needed by the second group. If the transferred capacity is not less than the transport capacity for the second group (S604: NO), system 100 goes back to method 500. And if the transferred capacity is less than the transport capacity for the second group (S604: YES), system 100 may proceed to step S606. In step S606, system 100 may divide the second group into a first sub-group and a second sub-group, wherein the first sub-group has a transport capacity corresponding to the transferred capacity. In step S608, system 100 may then assign the transferred capacity to the first sub-group, and designate the first sub-group as a subsequent group of the first group. System 100 may also designate a second sub-group as a parent group because it has no preceding group, and assign the second sub-group with the transport capacity it needs.

In some embodiments, when a current group has enough transport capacity for its subsequent group, system 100 may assign the transport capacity to the subsequent group after the transport tasks for the current group are finished. In some embodiments, when a current group does not have enough transport capacity for its subsequent group, system 100 may assign transport capacity from another preceding group to the subsequent group. That is, one group may receive transport capacity from more than one preceding groups.

With reference back to FIG. 5, in step S508, system 100 may search for transport capacity for the groups. Generally, the transport capacity that a transport service provider can offer depends on the vehicle. System 100 may search for available vehicles from top down the chain, e.g., starting from the parent group first. As discussed above, system 100 may receive transport capacity information from the transport service provider, indicating the capacity and location of his/her vehicle. Based on the acquired transport capacity information, system 100 may search for available vehicles in a neighborhood. The neighborhood may be expanded if not enough transport capacity associated with the vehicles can be found.

System 100 may assign the transport capacity to each group. In some embodiments, system 100 may generate a combination of vehicles according to the transport capacity of each vehicle and the transport tasks in the group, and determine a combination of vehicles for the group. For example, a group may include 20 passengers, and the combination of vehicles can be four 3-passenger vehicles and two 4-passenger vehicles. That is, a combination of six vehicles can be provided to the group to take the 20 passengers. It is contemplated that, more than one combinations of vehicles can be generated given enough available vehicles.

To improve efficiency of the car-pooling service, transport tasks for each of the passengers in one vehicle preferably have same or similar origins, destinations, departure times, and arrival times. That is, transport tasks assigned to one vehicle are preferably similar in order to improve the efficiency. Therefore, in some embodiments, step S508 may further include a method for assigning transport tasks to respective vehicles.

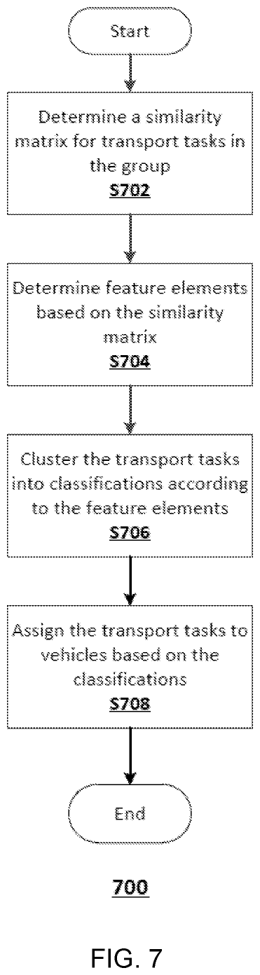

For example, FIG. 7 is a flowchart of an exemplary method 700 for assigning transport tasks to respective vehicles, according to embodiments of the disclosure. Method 700 can include steps S702-S708 as below.

In step S702, system 100 may determine a similarity matrix for the transport tasks in the group. The similarity matrix of the transport tasks can be generated using a similarity model. The similarity model can compare, for example, the origins, the destinations, the departure times, the arrival times, and other features of the transport tasks to generate the similarity matrix.

In step S704, system 100 may determine feature elements based on the similarity matrix. The similarity matrix can be converted to a Laplace matrix to generate feature elements for each of the transport tasks.

In step S706, system 100 may cluster the transport tasks into a predetermined number of classifications according to the feature elements. In some embodiments, the predetermined number can be the number of vehicles for the group determined in step S508. Generally, the transport tasks having same or similar feature elements will be clustered into a same classification (e.g., a same vehicle) as much as possible. That is, a correspondence relationship between a transport task and a vehicle can be established in this step. The method for clustering can be a K-means method or a density-based clustering method (e.g., a maximum density method). It is contemplated that, the method for clustering is not limited by the above exemplary methods.

In step S708, system 100 may assign the transport tasks to each vehicle based on the classifications. Because the correspondence relationship between a transport task and a vehicle has been established, system 100 may assign the transport tasks to vehicles respectively.

As discussed in step S508, more than one combinations of vehicles can be generated. And for each combination, according to the above method 700, a transport task may be assigned to a first vehicle that is different from a second vehicle, which the same transport task can be assigned to in another combination. That is, provided with more than one combinations determined in step S508, a passenger may have more than one choices of vehicles. In some embodiments, the car-pooling platform may allow the passenger to review choices of vehicles, to which his/her transport task has been assigned.

It is contemplated that, if the combination for a parent group changes, the combinations for subsequent group(s) may also change.

Yet another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods. Although the embodiments are described using vehicles to provide a car-pooling service to passengers as an example, the disclosed systems and methods can be applied to any transport service. For example, the transport tasks can be associated with cargos, rather than passengers described above. And the vehicles in embodiments of the disclosure can be non-motorized vehicles.

It is intended that the specification and examples be considered as exemplary only, with a true scope being indicated by the following claims and their equivalents.

What is claimed is:

1. A computer-implemented method for providing transport service, comprising:
receiving, via a communication interface, transport tasks within an area;
clustering, by a processor, the transport tasks into groups;
searching for, by the processor, transport capacity for the groups; and
assigning, via the communication interface, the transport capacity to each group.

2. The computer-implemented method of claim 1, wherein the transport tasks are clustered according to at least one of an origin, a destination, or a departure time of each transport task.

3. The computer-implemented method of claim 2, further comprising:
determining a rendezvous time based on the departure times of the transport tasks in each group, wherein the rendezvous time of each group is an average departure time of transport tasks in the respective group; and
ordering the groups according to the rendezvous times associated with the respective groups.

4. The computer-implemented method of claim 3, wherein ordering the groups according to rendezvous times of the respective groups further comprises: determining a preceding group or a subsequent group for each group.

5. The computer-implemented method of claim 4, further comprising when a group has no preceding group, determining the group as a parent group.

6. The computer-implemented method of claim 3, further comprising:
determining a capacity to be transferred from a first group to a second group;
dividing the second group into a first sub-group and a second sub-group when the transferred capacity is less than the transport capacity for the second group;
assigning the transferred capacity to the first sub-group; and
designating the second sub-group as a parent group.

7. The computer-implemented method of claim 1, wherein assigning the transport capacity to each group further comprises:
determining a similarity matrix for the transport tasks in the group;
determining feature elements based on the similarity matrix;
clustering the transport tasks into a predetermined number of classifications according to the feature elements; and
assigning the transport tasks to the at least one vehicle based on the classification.

8. The computer-implemented method of claim 7, wherein the similarity matrix is transformed into a Laplace matrix to determine the feature elements.

9. The computer-implemented method of claim 7, wherein the predetermined number is a number of the vehicles.

10. The computer-implemented method of claim 4, wherein the preceding group or the subsequent group for each group are determined based on the rendezvous time of the group using a greedy algorithm.

11. A system for providing transport service, comprising:
a communication interface configured to receive transport tasks within an area;
a memory; and
a processor coupled to the communication interface and the memory, and configured to:
cluster the transport tasks into groups;
search for transport capacity for the groups; and
assign the transport capacity to each group.

12. The system of claim 11, wherein the transport tasks are clustered according to at least one of an origin, a destination, or a departure time of each transport task.

13. The system of claim 12, wherein the processor is further configured to
determine a rendezvous time based on the departure times of the transport tasks in each group, wherein the rendezvous time of each group is an average departure time of transport tasks in the respective group; and
order the groups according to the rendezvous times associated with the respective groups.

14. The system of claim 11, wherein the processor is further configured to determine a preceding group or a subsequent group for each group.

15. The system of claim 14, wherein the processor is further configured to determine a group as a parent group, when the group has no preceding group.

16. The system of claim 13, wherein the processor is further configured to:
determine a capacity to be transferred from a first group to a second group;
divide the second group into a first sub-group and a second sub-group when the transferred capacity is less than the transport capacity for the second group;
assign the transferred capacity to the first sub-group; and
designate the second sub-group as a parent group.

17. The system of claim 11, wherein the processor is further configured to:
determine a similarity matrix for the transport tasks in the group;
determine feature elements based on the similarity matrix;
cluster the transport tasks into a predetermined number of classifications according to the feature elements; and
assign the transport tasks to a plurality of vehicles based on the classifications.

18. The system of claim 17, wherein the similarity matrix is transformed into a Laplace matrix to determine the feature elements.

19. The system of claim 17, wherein the predetermined number is a number of the vehicles.

20. A non-transitory computer-readable medium that stores a set of instructions, when executed by at least one processor of an electronic device, cause the electronic device to perform a method for providing transport service, the method comprising:
receiving transport tasks within an area;
clustering the transport tasks into groups;
searching for transport capacity for the groups; and
assigning the transport capacity to each group.
